(19) United States
(12) Patent Application Publication
(10) Pub. No.: US 2015/0251231 A1
(43) Pub. Date: Sep. 10, 2015

(54) OPERATION OF LANDFILL SITES

(71) Applicant: C.P.S. Environmental Services Limited, Nottingham (GB)

(72) Inventor: Paul Mullins, Nottingham (GB)

(73) Assignee: C.P.S. Enviromental Services Limited, Nottingham (GB)

(21) Appl. No.: 14/426,023

(22) PCT Filed: Sep. 2, 2013
(86) PCT No.: PCT/GB2013/052293

§ 371 Date: Mar. 4, 2015

(30) Foreign Application Priority Data
Sep. 4, 2012 (GB) 1215755.8
Sep. 29, 2012 (GB) 1217497.5

(51) Int. Cl. B09B 5/00; F04C 2/107; G05D 9/00

(52) U.S. Cl. CPC B09B 5/00; G05D 9/00; F04C 2/1071

(57) ABSTRACT

A landfill 10 is lined with an impermeable liner material at 12 and filled with waste, such as household waste. When the landfill is full, it is capped by a cap 14. Degradation of the body of waste material within the landfill creates leachate liquid as a byproduct. Without intervention, the leachate will form a layer 16 of saturated waste material at the bottom of the landfill 10. An extraction well 22 allows leachate to be drawn from the landfill 10 by a pump 26. Injection wells 24 allow leachate to be reintroduced into the landfill 10. Various sensors 36, 38, 40 take measurements associated with the wells 24. Leachate delivery is controlled in accordance with the values obtained. The obtained values may include the leachate head in the well and/or the volume or rate of leachate delivery to the well and/or the elapsed time since commencement of leachate delivery to the well and/or the rate of dispersion of the leachate into the landfill from the well.

The present invention relates to improvements in or relating to operation of landfill sites.

Landfill sites have been in widespread use for many years, for disposal of a wide range of waste material, such as household waste. In one regime of landfill site management, the landfill is lined before filling begins, and is capped when the site is full. This leaves a fully encapsulated body of waste material, at least some of which is putrescible and begins to degrade. The degradation results in the release of gases, which can be tapped from the landfill for power generation. In the absence of any intervention, liquid (called leachate) will tend to collect at the bottom of the landfill as degradation occurs, and the top of the landfill will tend to become very dry. The top of the landfill will typically be too dry for further degradation, and may represent a fire hazard. The bottom of the landfill will typically be too wet for further degradation, and may contain high concentrations of toxic substances. An intermediate level may exist, between the dry and wet levels, in which the waste material is sufficiently moist for degradation to occur.

It is desirable to manage the landfill to encourage degradation to occur. To this end, previous proposals have suggested circulating leachate from the bottom to the top of the landfill. Nevertheless, conventionally managed landfill sites remain potentially hazardous (for fire or for leakage of toxic materials) for long periods of time, perhaps 50 years or more. Landfill operators retain liability during this long period, known as the liability retention period.

Examples of the present invention provide a method of operating a landfill site containing a body of waste material which degrades in the presence of moisture to create leachate, the method including extracting leachate from the landfill and reintroducing leachate into the landfill through at least one well formed in the landfill, and wherein measurements are taken from sensors associated with the or at least one well to obtain values relating to the leachate delivered to the well, and wherein leachate delivery to the well is controlled in accordance with the values obtained.

The obtained values may include at least one of:

(A) the leachate head in the well;

(B) the volume or rate of leachate delivery to the well;

(C) the elapsed time since commencement of leachate delivery to the well; and

(D) the rate of dispersion of the leachate into the landfill from the well.

Leachate delivery may be discontinued to the well when the or any of the obtained values passes a corresponding threshold value. Leachate delivery may be discontinued when any of the obtained values exceed a corresponding upper threshold value. One or more of the obtained values may have corresponding upper and lower threshold values. One or more of the obtained values may be obtained as a range of values within which the current value lies. One or more of the obtained values may be measured, at least one other obtained value being calculated from the measurements made. The rate of dispersion of the leachate into the landfill from the well may be calculated from measured values.

Measurements may be taken continuously or repeatedly while leachate delivery is in progress. Measurements may be taken repeatedly at intervals less than 1 min apart. Measurements may be taken repeatedly at intervals less than 10 seconds apart.

An automatic process may be used to control leachate delivery in accordance with the obtained values. The automatic process may be used to compare obtained values and threshold values and to cause leachate delivery to discontinue.

After discontinuing leachate delivery to a well, leachate delivery to a different well may be commenced.

Leachate may be delivered by a pump at constant rate and/or pressure. The pump may be a fixed speed pump, and may be a helical rotor pump. Leachate flow may be measured by a vortex flow meter. Leachate level may be measured by a level sensor in the well.

Examples of the present invention also provide computer software which, when run on a general purpose computing device, executes the method of any of the preceding definitions.

Examples of the present invention also provide apparatus for use in operating a landfill site containing a body of waste material which degrades in the presence of moisture to create leachate, there being an extraction arrangement for extracting leachate from the landfill and at least one well formed in the landfill, for reintroduction of leachate into the landfill; wherein the apparatus comprises a controller operable to receive measurements taken by sensors associated with the or at least one well to obtain values relating to the leachate delivered to the well, and wherein the controller controls leachate delivery to the well, in accordance with the values obtained.

The obtained values may include at least one of:

(A) the leachate head in the well;

(B) the volume or rate of leachate delivery to the well;

(C) the elapsed time since commencement of leachate delivery to the well; and

(D) the rate of dispersion of the leachate into the landfill from the well.

The controller may be operable to compare each obtained value with a corresponding threshold value, and to cause leachate delivery to be discontinued to the well when any of the obtained values passes the corresponding threshold value. The controller may be operable to cause leachate delivery to be discontinued when any of the obtained values exceed a corresponding upper threshold value. One or more of the obtained values may have corresponding upper and lower threshold values. One or more of the obtained values may be obtained as a range of values within which the current value lies. One or more of the obtained values may be provided to the controller as a measurement from a sensor, there being at least one other obtained value which is calculated by the controller from measurements provided to the controller from one or more of the sensors. The controller may calculate the rate of dispersion of the leachate into the landfill from the well from measured values.

The apparatus may be operable to obtain values continuously or repeatedly while leachate delivery is in progress. Values may be obtained repeatedly at intervals less than 1 min apart. Values may be obtained repeatedly at intervals less than 10 seconds apart.

The controller may be operable to compare obtained values and threshold values and automatically to cause leachate delivery to discontinue. After discontinuing leachate delivery to a well, the controller may be operable to commence leachate delivery to a different well.

The apparatus may comprise a pump for leachate delivery at a constant rate and/or pressure. The pump may be a fixed speed pump, and may be a helical rotor pump The apparatus may comprise a vortex flow meter for measuring leachate flow. The apparatus may comprise a level sensor in the well, for measuring leachate level.

Examples of the present invention will now be described in more detail, with reference to the accompanying drawings, in which:

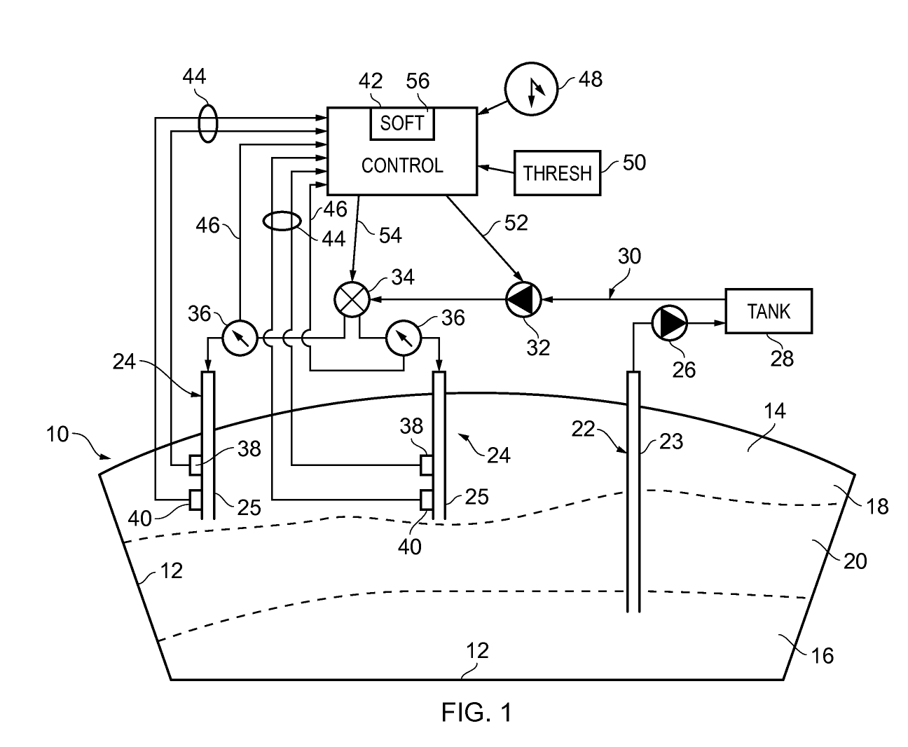

FIG. 1 is a schematic diagram of a landfill being operated in accordance with the method to be described; and

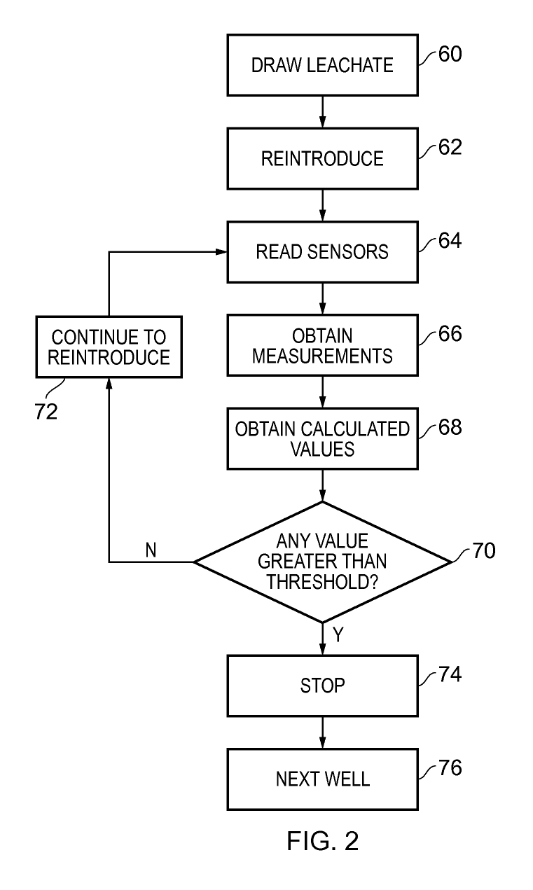

FIG. 2 is a simplified flow diagram of the method of operation of the landfill of FIG. 1.

### BACKGROUND

FIG. 1 illustrates a landfill 10 managed by a regime to be described below. The landfill 10 may have a depth of 50 m or more, and may extend over an area of between 10 and 500 hectares or more. The lower boundaries 12 of the landfill 10 are lined with an impermeable liner material to prevent leakage. While the landfill 10 is open for use, waste material of many different sorts is introduced from above. This may be household waste (sometimes known as MSW—Municipal solid waste). Rainfall or other precipitation also enters the waste and percolates through the waste material. When the landfill 10 is full, it is capped by a cap 14. This is intended to seal the landfill 10, particularly against leakage of pollutants and to prevent further rainfall entering the waste cell. The body of waste material within the landfill 10 will then begin to degrade. One byproduct will be leachate. Leachate is liquid which drains from the degrading waste material. Without intervention, the leachate will travel down to form a layer 16 of saturated waste material at the bottom of the landfill 10. A dry upper layer 18 is left at the top of the landfill 10. The rate of leachate movement will depend on the drainable porosity of the waste material. Neither the saturated layer 16, nor the upper layer 18 is able to degrade, being too wet and too dry, respectively. An intermediate moist layer 20 exists between the layers 16, 18, in which the moisture levels are suitable for further degradation. This is known as the active area or active region, and is the primary source of landfill gas (LFG) which can be extracted for energy generation. An extraction well 22 may be used to extract leachate from the saturated layer 16, for reintroduction at the top of the landfill 10, through one or more injection wells 24. This process of leachate recirculation is intended to create moisture conditions which are more even throughout the landfill 10, thereby increasing the size of the active area 20.

Apparatus

As noted above, the landfill 10 has an associated extraction well 22, allowing leachate to be drawn from the landfill 10 by a pump 26. Details of the structure of the extraction well 22 do not form part of the present invention. Any mechanism for extracting leachate could be used as a leachate well. The extraction well 22 may include a perforated pipe 23 surrounded by an annular column of gravel or other particulate material, allowing leachate to flow into the pipe 23. Extracted leachate may optionally be taken to a holding tank 28, which may alternatively be a containment vessel, lagoon, pond or other containment facility. In a practical example, it is likely that many more extraction wells will be provided, in an array across the landfill 10.

Leachate can be reintroduced into the landfill 10 through the injection wells 24. In this example, only two injection wells 24 are illustrated in order to explain the principles being described. In practice, it is likely that many more than two injection wells 24 would be used, in an array across the whole of the landfill 10.

Details of the structure of the injection wells 24 do not form part of the present invention. Many different structures could be used. The injection wells 24 may be pin wells which each include a perforated pipe 25 driven into the waste material by impact, and surrounded by an annular column of gravel or other particulate material, allowing leachate to flow from the pipe 25, back into the landfill 10. Leachate may be supplied to the injection wells 24 from the holding tank 28 or equivalent, if provided, or leachate may be supplied directly from an extraction well 22. Delivery to the wells 24 is achieved by connecting pipe work 30. The pipework 30 includes a pump 32 for pumping leachate into the injection wells 24, and a valve arrangement 34 which can be reconfigured to direct leachate to a selected one or more of the injection wells 24. The pump 32 is preferably a fixed speed pump and may be a helical rotor pump using a driven helical member to propel leachate. A helical rotor pump can provide constant delivery rate and delivery pressure, which is expected to be advantageous in the circumstances being described. Other types of pump could alternatively be used. It will be apparent that in a large landfill 10, with many extraction wells 22 and many injection wells 24, the pipework 30 and the necessary valve arrangements 34 will be considerably more complex than is suggested by FIG. 1. However, the principles of operation now being described will be equally applicable.

The pipework 30 also includes sensors 36, here illustrated as flowmeters. In this example, each flowmeter may be a vortex flow meter which includes a helical vortex member caused to spin by the passage of leachate, and an arrangement for measuring the speed at which the vortex member is spinning, in order to determine the flow rate through the meter. Other types of flowmeter could be used. In this example, a separate flowmeter 36 is provided for each injection well 24 to provide a measurement specific to that injection well. In alternative arrangements, there may be fewer sensors 36 than there are injection wells 24. A knowledge of the setting of the valves 34 would then allow a reading from the sensor 36 to be attributed to a particular injection well 24 (or group of wells 24). Sensors can therefore be associated permanently or temporarily with a particular injection well 24.

Each injection well 24 also has at least one sensor 38. In this example, each injection well 24 has two sensors 38, 40. The sensors 38 are positioned relatively high on the pipe 25. The sensors 40 are positioned relatively low on the pipe 25. The purpose of the sensors 38, 40 is to detect leachate in the pipe 25, at the corresponding height. Accordingly, the upper sensors 38 can detect, by simple binary operation, when the leachate level rises above or falls below the height of the sensor 38. The lower sensors 40 can operate in similar manner.

Controller

A controller 42 is also illustrated in FIG. 1. The controller 42 receives various inputs. In this example, these include inputs 44 from the sensors 38, 40. These provide data about the level of leachate in the corresponding injection well 24. The controller 42 also receives inputs 46 from the flowmeters 36, providing data about flow rates in the pipework 30. In particular, the inputs 46 provide data about the flow rate of leachate into the corresponding injection well 24, or into the injection well 24 which is currently being supplied. The controller 42 also has an associated clock function 48, providing time information to the controller 42. The controller 42 has access to threshold data indicated at 50. The threshold data may be in the form of a look-up table. The purpose and use of the threshold data 50 will become apparent later in this description.

The controller 42 provides various outputs. These include one or both of an output 52 to the pump 32 and an output 54 to the valves 34. The outputs 52, 54 allow the controller 42 to control the pump 32 and the valves 34. In particular, the outputs 52, 54 allow the controller 42 to control leachate delivery, which may include starting or discontinuing leachate delivery to a particular well, or may include varying the rate of delivery.

The controller 42 may be embodied as a general purpose computing device operating under the control of software 56. The skilled reader will be aware of many technologies available for receiving data from sensors, for processing by a software-controlled general purpose computing device, and for providing outputs from the device, for controlling other apparatus. Accordingly, no detailed description of the apparatus of the controller 42 is given here.

Method

When the apparatus being described above is in use, measurements are taken from sensors 36, 38, 40 associated with each injection well 24. This allows the controller 42 to obtain various values relating to the delivery of leachate to the well. The controller 42 is then able to control leachate delivery to the well, in accordance with the values obtained. In this example, the controller 42 obtains values for at least one of:

(A) the leachate head in the well 24;

(B) the volume or rate of leachate delivery to the well 24;

(C) the elapsed time since commencement of leachate delivery to the well 24; and

(D) the rate of dispersion of the leachate into the landfill 10 from the well.

The controller 42 controls leachate delivery in accordance with these obtained values. The controller 42 may cause leachate delivery to be discontinued when any of the obtained values passes a corresponding threshold value. These threshold values are available to the controller 42, at 50.

This method is illustrated in more detail in FIG. 2. Initially, the pump 26 operates to begin drawing leachate from the landfill 10, through the extraction well 22. This is step 60. The controller 42 configures the valves 34 and operates the pump 32 in order to direct leachate to a selected injection well 24 (or group of injection wells 24). This is step 62. The controller 42 then begins to take measurements, using the inputs 44, 46. Measurements are taken continuously or repeatedly. In particular, measurements are taken while leachate delivery is in progress. Measurements may be taken repeatedly at intervals less than 1 min apart or may be taken more frequently than this, such as at intervals less than 10 seconds apart.

The purpose of this regime is to allow the controller 42 to conduct continuous or pseudo-continuous monitoring of conditions associated with the injection well 24 being used. Thus, the inputs 44, 46 from the sensors 36, 38, 40 are read by the controller 42 at step 64. The controller 42 uses these inputs 44, 46 to obtain the four values noted above.

One or more of the obtained values may be obtained as a range of values within which the current value lies. For example, the state of the sensors 38, 40 allows the controller 42 to determine if the height of leachate within the injection well 24 lies between the upper and lower heights represented by the sensors 38, 40. This represents a measurement of the head of leachate in the well 24, between upper and lower values corresponding with the positions of the sensors 38, 40. One or more of the obtained values may be measured, with at least one of the other obtained values being calculated from the measurements made. For example, the leachate level in the injection well 24 is measured, in this example, by the sensors 38, 40, and the volume or rate of leachate delivery to the well 24 is measured by the flow sensors 36, and the elapsed time since the commencement of leachate delivery to the well 24 is measured by the clock. These measurements allow the rate of dispersion of the leachate into the landfill (through the injection well 24 which is in use) to be calculated by the controller 42. This may be by means of an appropriate algorithm of any required degree of complexity. In a simple example, the calculation can be made from the volume of leachate delivered to the injection well 24, and the current height (head) of leachate within the well 24. Knowledge of the geometry of the well 24 then allows a calculation of the volume of leachate which has left the well 24, into the landfill 10. The rate can be calculated from this value and the time elapsed.

Thus, the controller 42 obtains measurements at step 66 and then obtains calculated values (if required) at step 68.

In the illustrated example, the controller 42 compares each of the obtained values with corresponding threshold values 50, at step 70. If none of the obtained values exceeds the corresponding threshold value 50, the controller 42 continues the leachate reintroduction process, at step 72. In an alternative example, the controller 42 may order a change in the manner of leachate delivery, such as a change in the rate of delivery, in accordance with a decision taken at step 70, on the basis of the values obtained at steps 66 and 68. Step 72 will then continue with leachate delivery modified, as required.

However, if step 70 determines that any of the obtained values exceeds the corresponding threshold value 50, or that leachate delivery should be discontinued for any other reason revealed by the obtained values, the controller 42 will take steps to discontinue leachate delivery through the injection well 24 which is currently in use, at step 74. This is achieved by the controller 42 issuing instructions on the outputs 52, 54 to control the pump 32 and/or the valves 34. In this example, leachate delivery is discontinued when any of the obtained values exceeds the corresponding upper threshold value, as will be explained below. In addition, one or more of the obtained values may have corresponding upper and lower threshold values, with leachate delivery also being discontinued when the value goes below the lower threshold value. In this example, leachate level in the well 24 has an upper threshold value (represented by the position of the upper sensor 38) and a lower threshold value (represented by the position of the lower sensor 40).

When the fluid level in the well 24 rises unacceptably, this is detected by reference to the corresponding upper threshold value at 50. An unacceptably high fluid level in the well 24 indicates that leachate is not passing at an appropriate rate from the well 24 into the landfill 10. This may be because the landfill 10 is saturated around the well 24, or may indicate that perched leachate is building up around the well 24 or may indicate other problems arising within the landfill 10, around the well 24. Accordingly, leachate delivery through the particular well 24 is discontinued when the fluid level is unacceptably high, and may be reduced when the fluid level begins to rise. This allows the region around the well 24 to relax, for example to allow perched leachate to disperse.

The term “perched leachate” refers to leachate which has collected in a pocket within waste material which is otherwise dry.

When the volume or flow rate delivered to the well 24 rises unacceptably, this is detected by reference to the corresponding upper threshold value at 50. An unacceptably high volume or flow rate delivered to the well indicates that leachate is passing too quickly from the well 24 into the landfill 10. This may be because the pressure of leachate has created preferential paths through the waste material within the landfill 10, so that leachate will pass along these preferential paths, substantially without interference, and thus quickly. This can be call “short circuiting”, by analogy with an electrical system. Short circuiting prevents the leachate being absorbed by the material within the landfill 10. Accordingly, leachate delivery through the particular well 24 is reduced as the flow rate begins to rise, or is discontinued when a threshold is exceeded. This allows the region around the well 24 to relax, closing any preferential paths which have formed.

When the elapsed time since commencement of leachate delivery to the well exceeds a corresponding upper threshold value at 50, the region around the particular well 24, currently in use, should desirably be allowed to relax, to absorb the leachate which has been introduced. Accordingly, leachate delivery to the particular well 24 is discontinued. Leachate delivery may be reduced, perhaps progressively, as the threshold time is approached.

When the rate of dispersion of the leachate into the landfill 10 rises unacceptably, this is detected by reference to the corresponding upper threshold value at 50. An unacceptably high rate of dispersion may be because preferential paths have been created, as noted above. Accordingly, leachate delivery to the particular well 24 is discontinued. Leachate delivery may be reduced, perhaps progressively, as the threshold rate of dispersion is approached.

After the controller 42 has stopped leachate delivery to the particular well 24 (step 74), the controller 42 may start to supply a different injection well 24, at step 76. This is achieved by sending appropriate outputs 52, 54 to reconfigure the valves 34 and to instruct the pump 32 to begin supplying the newly selected well 24.

Concluding Remarks

In the examples described above, the introduction of leachate into the landfill 10, through the injection wells 24, is actively monitored and actively managed. In particular, this management includes early detection of saturation of the landfill contents, or of perched leachate, or of the genesis of preferential leachate pathways within the landfill 10. The use of the apparatus and methods described above is expected to allow leachate reintroduction to be maximised in the interests of speed of degradation of the landfill contents, and an increased rate of generation of extractable landfill gas. This is expected to be without causing unacceptable risks of problems arising. Problems can include regions of perched leachate, or problems of flooded or saturated regions. Other possible problems include fracture or instability within the waste material in the landfill 10 (particularly problems arising from excess hydrostatic pressure of leachate within the body of waste material). Preferential pathways forming in the waste material are another potential problem which are expected to be less of a risk. These cause the leachate reintroduction process to be short-circuited, preventing the leachate from being absorbed by the body of waste material and thus likely to give rise to increases in toxicity, particularly ammonia production.

Many variations and modifications can be made to the apparatus and methods described above. In particular, many different structures and technologies could be used to implement the process of leachate extraction, leachate reintroduction and control.

The examples set out above have referred to a lined landfill. It is envisaged that the apparatus and methods could also be used with recirculation of leachate in an unlined landfill site (often called a “dilute and dispense” site).

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-41. (canceled)

42. A method of operating a landfill site containing a body of waste material which degrades in the presence of moisture to create leachate, the method including extracting leachate from the landfill and reintroducing leachate into the landfill through at least one well formed in the landfill, and wherein measurements are taken from sensors associated with the or at least one well to obtain values relating to the leachate delivered to the well, and wherein leachate delivery to the well is controlled in accordance with the values obtained.

43. A method according to claim 42, wherein the obtained values include at least one of:
(A) the leachate head in the well;
(B) the volume or rate of leachate delivery to the well;
(C) the elapsed time since commencement of leachate delivery to the well; and
(D) the rate of dispersion of the leachate into the landfill from the well.

44. A method according to claim 42, wherein leachate delivery is discontinued to the well when the or any of the obtained values passes a corresponding threshold value.

45. A method according to claim 44, wherein one or more of the obtained values has corresponding upper and lower threshold values.

46. A method according to claim 42, wherein the rate of dispersion of the leachate into the landfill from the well is calculated from measured values.

47. A method according to claim 42, wherein after discontinuing leachate delivery to a well, leachate delivery to a different well is commenced.

48. A method according to claim 42, wherein leachate is delivered by a pump at constant rate and/or pressure.

49. A method according to claim 42, wherein the pump is a fixed speed pump.

50. A method according to claim 48, wherein the pump is a helical rotor pump.

51. A method according to claim 42, wherein leachate flow is measured by a vortex flow meter.

52. Computer software which, when run on a general purpose computing device, executes the method of claim 42.

53. Apparatus for use in operating a landfill site containing a body of waste material which degrades in the presence of moisture to create leachate, there being an extraction arrangement for extracting leachate from the landfill and at least one well formed in the landfill, for reintroduction of leachate into the landfill;
wherein the apparatus comprises a controller operable to receive measurements taken by sensors associated with the or at least one well to obtain values relating to the leachate delivered to the well, and wherein the controller controls leachate delivery to the well, in accordance with the values obtained.

54. Apparatus according to claim 53, wherein the obtained values include at least one of:
(A) the leachate head in the well;
(B) the volume or rate of leachate delivery to the well;
(C) the elapsed time since commencement of leachate delivery to the well; and
(D) the rate of dispersion of the leachate into the landfill from the well.

55. Apparatus according to claim 53, wherein the controller is operable to compare each obtained value with a corresponding threshold value, and to cause leachate delivery to be discontinued to the well when any of the obtained values passes the corresponding threshold value.

56. Apparatus according to claim 55, wherein one or more of the obtained values has corresponding upper and lower threshold values.

57. Apparatus according to claim 53, wherein the controller is operable to calculate the rate of dispersion of the leachate into the landfill from the well from measured values.

58. Apparatus according to claim 53, wherein after discontinuing leachate delivery to a well, the controller is operable to commence leachate delivery to a different well.

59. Apparatus according to claim 53, wherein the apparatus comprises a pump for leachate delivery at a constant rate and/or pressure.

60. Apparatus according to claim 59, wherein the pump is a fixed speed pump.

61. Apparatus according to claim 59, wherein the pump is a helical rotor pump.

62. Apparatus according to claim 53, comprising a vortex flow meter for measuring leachate flow.

63. Apparatus according to claim 53, comprising a level sensor in the well, for measuring leachate level.
